(19) United States
(12) Patent Application Publication
(10) Pub. No.: US 2017/0142960 A1
(43) Pub. Date: May 25, 2017

(54) INTERNET CONTROLLED HUNTING DECOY

(71) Applicant: Clinton Bland Patterson, Fort Mill, SC (US)

(72) Inventor: Clinton Bland Patterson, Fort Mill, SC (US)

(21) Appl. No.: 15/359,821

(22) Filed: Nov. 23, 2016

Related U.S. Application Data
(60) Provisional application No. 62/260,057, filed on Nov. 25, 2015.

(51) Int. Cl. A01M 31/06; H04N 5/225; G08C 17/02

(52) U.S. Cl. CPC A01M 31/06; G08C 17/02; H04N 5/2253

(57) ABSTRACT

An internet controlled hunting decoy allows hunters to remotely control the decoy, regardless of their physical proximity to the decoy. An internet enabled microcontroller communicates with the internet, and provides signals to a plurality of motors to control the movements or other decoy features of the system. Control of the micro controller may be provided by a computing device operatively connected to the internet. The decoy may be put into a sleep mode in between hunting activity sequences and started and stopped by the hunter as desired.

### CROSS-REFERENCE TO RELATED APPLICATION

This application claims the benefit of priority of U.S. provisional application No. 62/260,057, filed Nov. 25, 2015, the contents of which are herein incorporated by reference.

### BACKGROUND OF THE INVENTION

The present invention relates to decoys, and more particularly to mechanical decoys for attracting wild game.

Current decoys systems that have mechanical or electro-mechanical movement are only controlled via radio waves (RC remotes), pull-strings, and on-board push buttons. Each method brings challenges. With RCs, the operator has to be within a certain distance of the decoy in order for the decoy to receive the transmitted signal. The operator also has to carry the remote control (it's just one more thing to lose).

With the pull-strings, the operator has to be very close to the decoy and pulling the string requires body movements, which most hunters don't like as it can alert wary game to the hunter's presence and otherwise disturb the game they are trying to lure or attract. On-board push buttons require that the decoy is constantly moving which gives outdoorsmen little control and uses a lot of batteries over the course of time.

In addition to the foregoing deficiencies, there is currently no available decoy on the market that allows a hunter to capture video of a hunt from the perspective of the decoy. This limits the number of vantage points a hunter videoing hunts can attain.

As can be seen, there is a need for an improved control system for game decoys.

### SUMMARY OF THE INVENTION

In one aspect of the present invention, a remote controlled game decoy, includes a decoy shell having a plurality of movable body parts operatively connected to one or more servo motor actuators. The game decoy also includes an internet-connected microcontroller configured for communication with a computer network and operable to provide a control signal to the one or more servo motor actuators.

In some embodiments, one of the plurality of movable body parts comprises a decoy head and the decoy is configured for rotational movement of the head about a neck axis. In some embodiments, one of the plurality of movable body parts comprises a decoy neck, wherein the decoy is configured for an up and down movement of the decoy neck to simulate a feeding movement. In other embodiments, the decoy is configured for a rotational movement about a vertical axis of the decoy.

Other aspects of the invention include an internet-connected computing device configured with a user interface providing one or more controls configured to operably control the one or more servo motor actuators. In other embodiments, the decoy may also include a camera attached to the decoy shell and oriented to capture images from a point of view of the remote controlled game decoy. The camera may also be controlled via a control presented on the user interface of the internet-connected computing device. The camera may be one of a video camera or a still image camera. The decoy shell may be configured as one of a game fowl; a varmint; a predator; or a hoofed animal.

In other aspects of the invention, a remote controlled game decoy, includes a decoy body having a plurality of movable body parts operatively connected to one or more servo motor actuators. A control unit operatively is connected to control the one or more servo motor actuators. The control unit is configured to receive an internet-connected microcontroller configured for communication with a computer network and operable to provide a control signal to the control unit for remote control of the one or more servo motor actuators.

The game decoy may also include a camera mounted to the decoy body and configured to take images from a point of view of the game decoy. IN other aspects of the invention, an internet-connected remote control unit is operable to provide a control signal to control the one or more servo motor actuators. The control signal may specify one or more of a neck movement action; a body movement action; and a head movement action. The control signal comprises a choreographed game decoy movement. The control signal may also include a sequence of choreographed game decoy movements.

In yet other aspects of the invention, a method of attracting game, includes the steps of: providing a decoy body having a plurality of movable body parts operatively connected to one or more servo motor actuators operable in response to a signal received via a communications network; and operating a control on a computing device connected to the communications network, wherein the control specifies sequence of instructions for a movement action of the one or more servo motor actuators.

These and other features, aspects and advantages of the present invention will become better understood with reference to the following drawings, description and claims.

### BRIEF DESCRIPTION OF THE DRAWINGS

FIG. 1 is a schematic view of the invention in use.

FIG. 2 is a digital device.

FIG. 3 is a schematic view show rotational aspects of the invention.

FIG. 4 is a schematic side elevation view.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention allows outdoorsmen to remotely control their decoys through the internet via a mobile device or other web connected interfaces.

As stated above, the present invention solves the problem of not being able to remotely communicate with and control wild game decoys through the internet. Currently decoys that can move are controlled through physical pull-strings, on-board push buttons, or via a remote Radio Control (RC) (radio waves). No invention exists to control decoys over HTTP, or the internet and thus no existing decoys are able to receive and submit data to the internet.

The present invention allows an operator to control decoy movements via the internet. That is, a hunter can control their decoys via a computing device, such as, a cell phone, a tablet, a laptop or desk top computer, etc. The computing device may control the decoy through an internet capable communications connection. This would happen through a mobile app or a mobile web interface.

The present invention allows hunters to remotely control the decoy without the need to be in physical proximity to the decoy. Regardless of the hunter's distance away from the decoy, the hunter can still control it. In addition, the present invention does not require hunters to carry a separate remote control to control the decoy. Since the hunter may already carry a smart phone with them, the present invention makes it more convenient to control the decoy.

Finally, the present invention uses energy wisely. Through the system of the present invention, the decoy may be controlled to put it in a sleep mode between sequences and may be started and stopped by the hunter as desired. This reduces the battery consumption by the decoy for its operation. The decoy uses a low-voltage power source, such as a battery and is re-chargeable.

Since the decoy is controlled over HTTP the software on the microcontroller can be remotely updated. If an improvement within the logic of the software is realized the decoy's firmware can also be remotely updated through the internet.

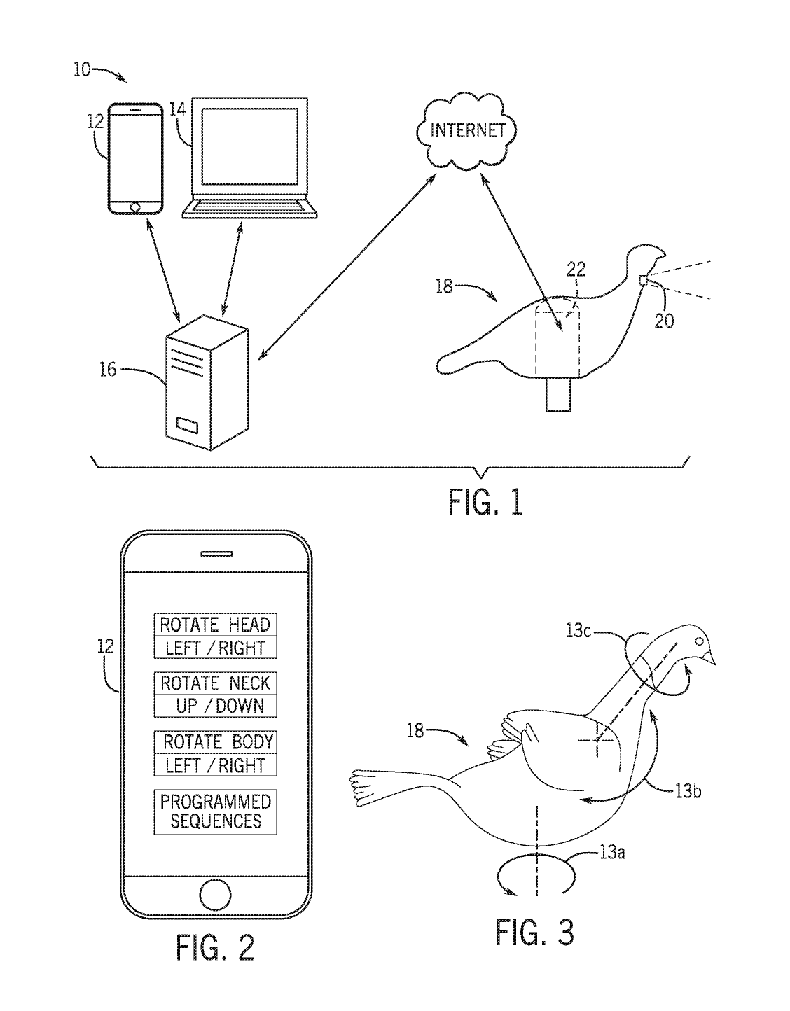

As seen in reference to FIG. 1, a game decoy 18 and control system 10 according to the present invention comprises an Internet-Connected Microcontroller 32, such as the PHOTONH manufactured by Particle in San Francisco, Calif., USA, the Arduino Uno with Wi-Fi Shield, manufactured by Arduino, LLC in Italy, or the Neo, manufactured by Aeris in Santa Clara, Calif., USA. The microcontroller 32 operatively connects the game decoy 18 of the system to the internet and the coded logic (firmware) provides signals, which control the movement and related features of the decoy 18. The control signals may be communicated via Hypertext Transfer Protocol (HTTP), which is an application protocol for distributed, collaborative, hypermedia information systems. The microcontroller 22 connects to the internet and executes the logic written in the application firmware.

The decoy 18 may be controlled by an internet connected computing device 14, which may also be a mobile computing device 12, such as a smart phone. The computing devices 12, 14 may be operatively connected to the internet via a communications server 16.

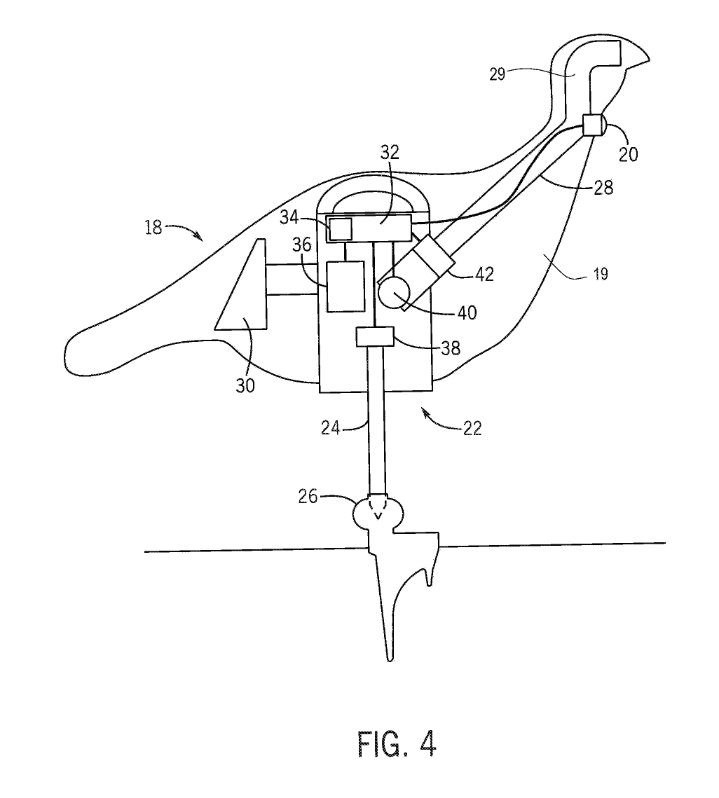

As seen in reference to FIG. 4, a decoy body housing 18 may provide an enclosure for the microcontroller 32, a battery 36, a stake 26, and servos 38, 40, 42 used throughout the decoy. The decoy body 18 may be secured or positioned in a decoy location with a ground stake 26 in order to keep the decoy in the ground and stabilizes the decoy so that it can move in its decoy movements. The decoy may include a decoy outer shell 19 of the decoy that visually makes the decoy look like a game animal (such as a turkey, a duck, a rabbit, etc.).

In a preferred embodiment, the decoy 18 is provided with a camera 20, which may be a video or still camera 20, which is oriented to capture images from a point of view of the decoy 18. As with the servos 38, 40, 42, the camera 20 may be controlled by the operator over the internet utilizing controls on the UI of the mobile computing device 12. In some instances, the camera 20 may also include a proximity sensing device, which may be selectively controlled via the UI to activate the camera when movement and/or thermal signals are detected in close proximity to the decoy 18. The camera 20 may store the captured images on a non-transient computer storage medium, such as a secure digital SD card, USB jump drive, or other storage device carried within the decoy 18.

Movement features of the decoy 18 are provided by a plurality of servos 38, 40, 42 that are triggered by signals from the microcontroller 32. The servos 38, 40, may be, for example, servo motors or stepper motors, which provide movement to one or more movable body parts of the decoy 18. According to aspects of the invention, the decoy 18 may include a head rotation servo 42. The head rotation servo 42 may provide mechanical movements to the decoy body, that may for example, twist the head from right to left as shown by arrow 13c of FIG. 3, when commanded to by Microcontroller 32 after receiving a user input via a user interface UI on the mobile computing device 12.

The decoy body may also be provided with a neck rotation servo 40 that may impart mechanical movement to parts of the decoy body, such as to lift the neck up and down movement simulating feeding, shown by arrow 13b of FIG. 3, when commanded to by the Microcontroller 32 after receiving a movement command entered by the operator on the UI of the mobile computing device 12.

In certain embodiments, the decoy 18 may also include a body rotation servo 38. The body rotation servo 38, may rotate or spin the entire decoy 18 right and left about a vertical axis of a stub 24, as shown by arrow 13a of FIG. 3, when commanded by the Microcontroller 32 after receiving command signal in response to a movement selected on the UI of the mobile computing device 12.

Power to operate the decoy 18 and control system 32 may be provided by a battery 36. The battery may be rechargeable and may include solar recharger for the battery 36. The decoy 18 may further comprise a counter weight 30. The counter weight 30 provides a counter weight to proportionally balance the decoy 18 with its movements via the servos 38, 40, 42 and to facilitate keeping the decoy 18 from tipping over.

The decoy 18 may further comprise a head rotation arm 29, which may be placed on top of the head rotation servo 42 and when the servo 42 operates it may cause the head to move right and left as this piece forces the outer shell 19 of the decoy 18 to rotate. The decoy 18 may further comprise a neck extension tube 28, which connects the head rotation servo 42 to the arm of the neck rotation servo 40.

When combining these pieces together the hunter gets a moving, lifelike, animated decoy 18 that can be remotely controlled and updated over the internet. The structural pieces support the decoy body 18, house the battery 36, and servos 38, 40, 42. The servos 38, 40, 42 may be controlled to cause the decoy's body to spin, neck to lift, and head to twist, such as shown in reference to FIG. 3.

The head rotation arm 29 and head rotation servo 42 may be connected to the neck rotation servo 40 via the neck extension tube 28. This tube 28 simulates neck movement when the neck rotation servo 40 is triggered from the internet-connected microcontroller 32.

The body housing 19 houses the core pieces of the structure, such as the battery 36, the microcontroller 32, the neck servo 40, and the counter weight 30, which connects to the ground stake 26. The counter-weight 30 provides balanced weight for the system of working parts. As the decoy 18 moves the counter weight 30 prevents the decoy from tipping over.

The ground stake 26 stabilizes the decoy when placed into the ground. This would typically be placed in dirt or grass. The ground stake 26 plugs into the body housing 18 beneath the body housing 18. The decoy outer-shell 19 covers all parts of the decoy except the ground stake 26. The outer-shell simulates the look of a live animal such as a turkey, duck, rabbit, deer, etc.

The microcontroller 32 has logic that is written to it, known as firmware. The firmware controls the movements of the decoy 18. The firmware may be written in Objective C coding language, or any suitable programming language. The firmware exposes web services from cloud web servers 16 which can send and receive data and control parameters. A web interface 12 is created that allows users to send parameters to these cloud functions which ultimately results in movement of the decoy.

Since the decoy 18 is controlled over HTTP, the software on the microcontroller 32 can be remotely updated. Similarly, if an improvement within the firmware is developed, it can be remotely updated to the decoys firmware through the internet. By way of example, in addition to providing control signals for individual movements of a particular body part, the software code may be programmed such that the movements of the decoy 18 may be choreographed through the respective servos 38, 40, 42 to replicate lifelike activities of the decoy 18, such as a feeding sequence, a resting sequence, an alert signal, an all clear signal sequence, a mating ritual, and the like. In order to reduce power consumption and noise some functions turn power on immediately before moving and then off immediately after moving.

While the outer shell 19 is necessary, different shells 19 can be applied based on the animal being simulated. For example, the shell design of a turkey on the decoy to simulate a turkey, a shell of a rabbit on the decoy to simulate a rabbit. In larger scenarios one could put the shell of a deer on it to simulate deer movement. The outer shell (or skin if you will) can change, but the movement of the parts may be controlled by the same servos, having different linkages depending on the shell dimensions. Given different animal scenarios the required weight of the counter-weight may vary as well.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A remote controlled game decoy, comprising:
a decoy shell having a plurality of movable body parts operatively connected to one or more servo motor actuators;
an internet-connected microcontroller configured for communication with a computer network and operable to provide a control signal to the one or more servo motor actuators.

2. The remote controlled game decoy of claim 1, wherein one of the plurality of movable body parts comprises a decoy head.

3. The remote controlled game decoy of claim 2, wherein the decoy is configured for rotational movement about a neck axis.

4. The remote controlled game decoy of claim 1, wherein one of the plurality of movable body parts comprises a decoy neck.

5. The remote controlled game decoy of claim 4, wherein the decoy is configured for an up and down movement of the decoy neck to simulate a feeding movement.

6. The remote controlled game decoy of claim 1, wherein the decoy is configured for a rotational movement about a vertical axis of the decoy.

7. The remote controlled game decoy of claim 1, further comprising:
an internet-connected computing device configured with a user interface providing one or more controls configured to operably control the one or more servo motor actuators.

8. The remote controlled game decoy of claim 7, further comprising:
a camera attached to the decoy shell and oriented to capture images from a point of view of the remote controlled game decoy.

9. The remote controlled game decoy of claim 8, wherein the camera is controlled via a control presented on the user interface of the internet-connected computing device.

10. The remote controlled game decoy of claim 8, wherein the camera is a video camera.

11. The remote controlled game decoy of claim 8, wherein the camera is a still image camera.

12. The remote controlled game decoy of claim 1, wherein the decoy shell is configured as one of a game fowl; a varmint; a predator; or a hoofed animal.

13. A remote controlled game decoy, comprising:
a decoy body having a plurality of movable body parts operatively connected to one or more servo motor actuators;
a control unit operatively connected to control the one or more servo motor actuators, wherein the control unit configured to receive an internet-connected microcontroller configured for communication with a computer network and operable to provide a control signal to the control unit for remote control of the one or more servo motor actuators.

14. The game decoy of claim 13, further comprising:
a camera mounted to the decoy body and configured to take images from a point of view of the game decoy.

15. The game decoy of claim 14, further comprising:
an internet-connected remote control unit operable to provide a control signal to control the one or more servo motor actuators.

16. The game decoy of claim 15, wherein the control signal comprises one or more of a neck movement action; a body movement action; and a head movement action.

17. The game decoy of claim 16, wherein the control signal comprises a choreographed game decoy movement.

18. The game decoy of claim 17, wherein the control signal further comprises a sequence of choreographed game decoy movements.

19. A method of attracting game, comprising:
providing a decoy body having a plurality of movable body parts operatively connected to one or more servo motor actuators operable in response to a signal received via a communications network;
operating a control on a computing device connected to the communications network, wherein the control specifies sequence of instructions for a movement action of the one or more servo motor actuators.
